(19) United States
(12) Patent Application Publication
(10) Pub. No.: US 2020/0325751 A1
(43) Pub. Date: Oct. 15, 2020

(54) MITIGATION OF CASING DEFORMATION ASSOCIATED WITH GEOLOGICAL SETTINGS PRONE TO CASING DEFORMATION POST HYDRAULIC FRACTURE INJECTION

(71) Applicant: Landmark Graphics Corporation, HOUSTON, TX (US)

(72) Inventors: Vivek Sharma, Gurgaon (IN); Mike Navarette, Tomball, TX (US)

(21) Appl. No.: 16/305,382

(22) PCT Filed: Jul. 8, 2016
(86) PCT No.: PCT/US2016/041545

§ 371 Date: Nov. 28, 2018

(51) Int. Cl. E21B 33/14; E21B 49/00; E21B 7/28; E21B 33/12; E21B 17/08; G01V 1/18; G01V 1/40

(52) U.S. Cl. CPC E21B 33/14; E21B 49/00; E21B 7/28; E21B 43/26; E21B 17/08; G01V 1/181; G01V 1/40; E21B 33/12

(57) ABSTRACT

An example method of mitigating casing deformation includes determining that a geologic area in a formation within a threshold distance of a cased wellbore is prone to formation relaxation. The method also includes altering a drilling plan for one or more wellbores to be drilled within the threshold distance of the wellbore.

### BACKGROUND

In the drilling of oil and gas wells, it is common to install a steel pipe or casing within the open wellbore in order to provide stability to the walls of the wellbore passing through the formation and to isolate and seal off formation fluid zones from one another. Typically, the casing is cemented in place in order to bond the casing to the wall of the wellbore. Thereafter, for unconventional reservoirs, various production techniques may be employed to extract hydrocarbons from the formation. Unconventional reservoirs are essentially any reservoir that requires special recovery operations outside the conventional operating practices. Unconventional reservoirs include reservoirs such as tight-gas sands, gas and oil shales, coalbed methane, heavy oil and tar sands, and gas-hydrate deposits. These reservoirs require assertive recovery solutions, such as stimulation treatments, steam injection, or hydraulic fracturing. During the processing of hydraulic fracturing, millions of gallons of water, sand, and chemicals may be pumped underground to break apart the rock and release the gas. For example, a pumper truck may inject the millions of gallons of water, sand, and chemicals at high pressure down and across into the horizontally drilled well as far as 10,000 feet below the Earth's surface.

One phenomenon that may be experienced in association with hydraulic fracturing is casing deformation, where the installed wellbore casing is pinched, ruptured or is otherwise impaired. Casing deformation can lead to a loss of pressure integrity of the well. Casing deformation may also inhibit the passage of tools and equipment through the area of casing deformation, which could lead to abandonment or redrilling of the wellbore after the hydraulic fracturing operations. Most of the solutions to casing deformation focus on increasing the strength of casing and modifying hydraulic fracturing treating pressure and thus far have resulted in a low success rate. Geo-mechanical engineers have studied the causes of casing deformation to better understand how to prevent them from occurring. Previous approaches to resolve casing deformation as a result of hydraulic fracturing have involved studying rock geo-mechanics, hydraulic fracturing pump rates and pressure impact on casing. For example, many geo-mechanical engineers came to the conclusion that the pump pressure at which the mixture is injected into the wellbore should stay within a particular pump window or pressure rate. It may be difficult, however, to maintain the pump pressure at a particular pump window or pressure rate because some wells are difficult to break down and hydraulically fracture. Accordingly, the particular pump window or pressure rate would not provide the needed result in order to successfully conduct hydraulic fracturing on the wellbore.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 illustrates a marine-based production system having a deviated wellbore subject to planar fracturing.

FIG. 2 illustrates a portion of the deviated wellbore of FIG. 1.

FIG. 3 is a block diagram of an exemplary computer system in which embodiments may be implemented.

FIG. 4 is a process flowchart of an exemplary method of identifying geologic areas in a formation that are prone to casing deformation in accordance with one or more embodiments.

FIG. 5 is a process flowchart of an exemplary method of mitigating casing deformation in accordance with one or more embodiments.

FIGS. 6A-6F are illustrations of hydraulic fracturing at different stages.

### DETAILED DESCRIPTION

The disclosure may repeat reference numerals and/or letters in the various examples or figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the top of the wellbore. Unless otherwise stated, the spatially relative terms are intended to encompass different orientations of the apparatus in use or operation in addition to the orientation depicted in the figures. For example, if an apparatus in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a figure may depict a horizontal wellbore or a vertical wellbore, unless indicated otherwise, it should be understood by those skilled in the art that the apparatus according to the present disclosure is equally well suited for use in wellbores having other orientations including vertical wellbores, deviated wellbores, multilateral wellbores or the like. Likewise, unless otherwise noted, even though a figure may depict an offshore operation, it should be understood by those skilled in the art that the apparatus according to the present disclosure is equally well suited for use in onshore operations and vice-versa. Further, unless otherwise noted, even though a figure may depict a cased hole, it should be understood by those skilled in the art that the apparatus according to the present disclosure is equally well suited for use in open hole operations.

As used in this Detailed Description, the term primary wellbore may refer to any wellbore from which another, intersecting wellbore has been or is to be subsequently drilled; whereas the term secondary wellbore may refer to any subsequently-drilled wellbore extending from (intersecting with) that primary wellbore. Thus, in any multilateral wellbore system, the initial wellbore drilled from the surface will invariably be the primary wellbore with respect to any one or more intersecting wellbores drilled therefrom, which are the secondary wellbores with respect to that initial wellbore drilled from surface. Each secondary wellbore may then itself become the “primary” wellbore with respect to any further (“secondary”) wellbore(s) drilled therefrom.

It has been observed that casing deformation during hydraulic fracturing is prevalent in tectonically active regions in the world, such as Asia Pacific (China, Australia), the Middle East (Saudi Arabia), South America (Colombia, Brazil, Argentina), and North America (USA). More specifically, casing deformation occurs in a geological setting where the vertical stress component is not the maximum stress value, allowing planar fractures to be generated when wells are hydraulically fractured. In these types of geological settings where planar fractures are present, formation relaxation, which occurs immediately following the hydraulic fracturing treatment, can impose point loads on the casing which results in buckling, deformation and/or shearing. Thus, in the foregoing, methods and systems are described which analyze formation relaxation for the purpose of predicting point loading which can lead to casing deformation, thereby permitting prophylactic measures to be taken during the planning and installation of wellbores in such tectonically active regions.

Casing deformation may refer to the change in the shape of the casing within a wellbore. As a result of the deformed shape, it is difficult for tools or equipment to pass through the damaged section of the wellbore. The extent of the casing deformation may be gauged by running a casing multi-arm caliper tool, impression block, or ultrasound image scanner into the wellbore.

Shear slippage is a formation property that can occur when there is an increase in pore pressure due to pressurized fluid injection into tectonically unstable regions created by plate movement giving rise to small stress perturbations in critically stressed faults and fractures. A localized shear slippage may show activity on micro-seismic sensors. A large shear slippage on big faults can be detected by surface seismographs. For example, an earthquake due to waste water injection is a form of shear slippage on faults. Shear slippage is inherent formation property similar to formation relaxation. Geological conditions that could give rise to the foregoing may include reverse/thrust fault regions as well as borderline strike slip/thrust fault regions.

In any event, as described herein, it may be advantageous to determine whether a geologic area in a formation within a threshold distance of a wellbore is prone to formation relaxation or shear slippage that could result in damage to the casing and wellbore. This information may provide builders with more information regarding the wellbore and whether geologic areas in the formation are prone to casing deformation, permitting mitigation steps to be taken prior to drilling of the wellbore. Mitigation may apply to both casing deformation and shear slippage if the wellbore is drilled in locations where there may be a likelihood of shear slippage, such as in critically stressed faults and fractures.

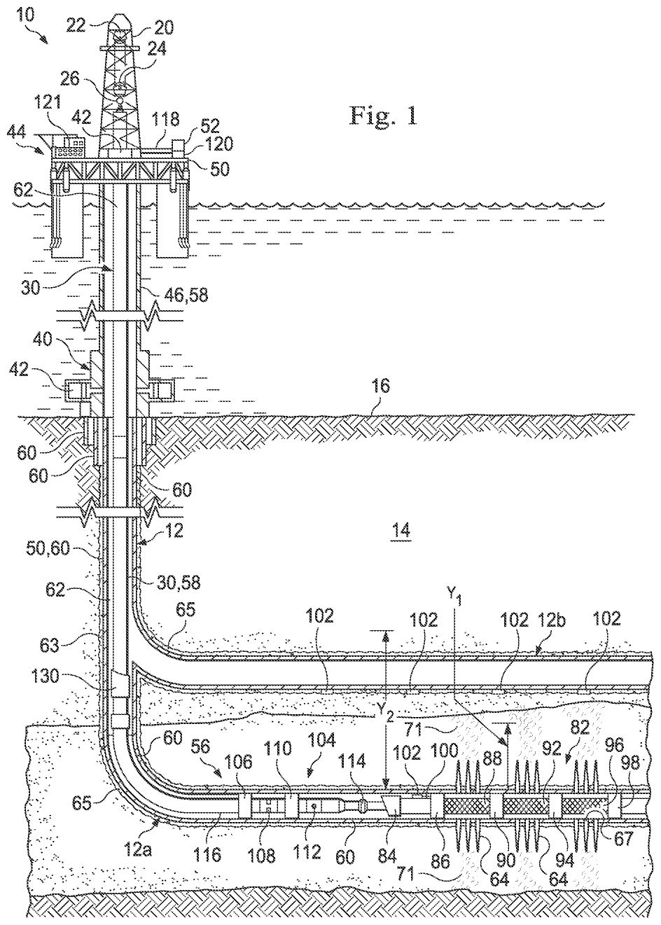

Turning to FIG. 1, shown is an elevation view in partial cross-section of a wellbore drilling and production system 10 utilized to produce hydrocarbons from wellbore 12 extending through various earth strata in an oil and gas formation 14 located below the earth's surface 16. Wellbore 12 may be a primary wellbore and may include one or more secondary wellbores 12a, 12b, . . . , 12n, extending into the formation 14, and disposed in any orientation and spacing, such as the horizontal secondary wellbores 12a, 12b illustrated.

Drilling and production system 10 may include a drilling rig or derrick 20. Drilling rig 20 may include a hoisting apparatus 22, a travel block 24, and a swivel 26 for raising and lowering casing, liner, drill pipe, work string, coiled tubing, production tubing (including production liner and production casing), and/or other types of pipe or tubing strings collectively referred to herein as tubing string 30, or other types of conveyance vehicles, such as wireline, slickline or cable. Tubing string 30 may be a substantially tubular, axially extending work string or production casing, formed of a plurality of pipe joints coupled together end-to-end supporting a completion assembly as described below.

Drilling rig 20 may be located proximate to a wellhead 40 (such as in a land-based system, not shown), or spaced apart from wellhead 40, such as in the case of an offshore arrangement as shown in FIG. 1. One or more pressure control devices 42, such as blowout preventers (BOPS) and other equipment associated with drilling or producing a wellbore may also be provided at wellhead 40 or elsewhere in the system 10.

For offshore operations, as shown in FIG. 1, whether drilling or production, drilling rig 20 may be mounted on an oil or gas platform 44, such as the offshore platform as illustrated, semi-submersibles, drill ships, and the like (not shown). Although system 10 of FIG. 1 is illustrated as being a marine-based production system, it may also be a land-based production system. In any event, for marine-based systems, one or more subsea conduits or risers 46 extend from deck 50 of platform 44 to a subsea wellhead 40. Tubing string 30 extends down from drilling rig 20, through subsea conduit 46 and BOP 42 into wellbore 12.

A working or service fluid source 52, such as a storage tank or vessel, may supply a working fluid 54 pumped to the upper end of tubing string 30 and flow through tubing string 30. Working fluid source 52 may supply any fluid utilized in wellbore operations, including without limitation, drilling fluid, cementing slurry, acidizing fluid, liquid water, steam, hydraulic fracturing fluid, propane, nitrogen, carbon dioxide or some other type of fluid.

Wellbore 12 may include subsurface equipment 56 disposed therein, such as, for example, a work string with tools carried on the work string, a completion string and completion equipment or some other type of wellbore tools or equipment.

Wellbore drilling and production system 10 may generally be characterized as having a pipe system 58. For purposes of this disclosure, pipe system 58 may include casing, risers, tubing, drill strings, completion or production strings, subs, heads or any other pipes, tubes or equipment that attaches to the foregoing, such as string 30 and conduit 46, as well as the primary and secondary wellbores in which the pipes, casing and strings may be deployed. In this regard, pipe system 58 may include one or more casing strings 60 that may be cemented in wellbore 12, such as the surface, intermediate and outer casings 60 shown in FIG. 1. An annulus 62 is formed between the walls of sets of adjacent tubular components, such as concentric casing strings 60 or the exterior of tubing string 30 and the inside wall of wellbore 12 or casing string 60, as the case may be.

Wellbore 12 is generally constructed of one or more boreholes 63 drilled into formation 14. Each cased borehole 63 will include a casing string 60 cemented in place, the cement forming a cement sheath 65 between the wall of the borehole 63 and the casing string 60. Casing string 60 may include apertures 67 formed in casing string 60 when perforations 69 are formed in formation 14. Each perforation 69 may include a network of fractures 71 extending from the perforation 69. In certain formations as illustrated in FIG. 1, the fracture network will generally be planar in shape as it radiates out from wellbore 12.

As shown in FIG. 1, subsurface equipment 56 is illustrated as completion equipment and tubing string 30 in fluid communication with the completion equipment 56 is illustrated as production tubing 30. Completion equipment 56 is disposed in a substantially horizontal portion of wellbore 12, which includes a lower completion assembly 82 having various tools such as an orientation and alignment subassembly 84, a packer 86, a sand control screen assembly 88, a packer 90, a sand control screen assembly 92, a packer 94, a sand control screen assembly 96 and a packer 98. Lower completion assembly 82 is generally positioned in wellbore 12 to be adjacent perforations 69, and in particular, the sand control screen assembly 88, 92, 96 is positioned in the vicinity of perforations 69.

Extending downhole from lower completion assembly 82 is one or more control lines 100 that pass through packers 86, 90, 94 and may be operably associated with one or more devices 102 associated with lower completion assembly 82. Control lines 100 may include hydraulic lines, electric lines, optic lines, etc. Cable devices 102 may be electric or optic devices, such as sensors, positioned downhole. Devices 102 may be sensors used to gather data and/or controllers or actuators used to operate downhole tools or fluid flow control devices. Cable 100 may operate as communication media, to transmit power, or data and the like between lower completion assembly 82 and an upper completion assembly 104. Data and other information may be communicated using electrical signals, optic signals, acoustic signals or other telemetry that can be converted to electrical signals at the rig 20 to, among other things, monitor the conditions of the environment and various tools in lower completion assembly 82 or other tool string.

In this regard, disposed in wellbore 12 at the lower end of tubing string 30 is an upper completion assembly 104 that includes various tools such as a packer 106, an expansion joint 108, a packer 110, a fluid flow control module 112 and an anchor assembly 114.

Extending uphole from upper completion assembly 104 are one or more control lines 116, such as hydraulic tubing, sensor cable or electric cable, which extends to the surface 16. Cable 116 may operate as communication media, to transmit power, signals or data and the like between a surface controller 121 and the upper and lower completion assemblies 104, 82, respectively.

Fluids, cuttings and other debris returning to surface 16 from wellbore 12 are directed by a flow line 118 to storage tanks 52 and/or processing systems 120, such as shakers, centrifuges and the like.

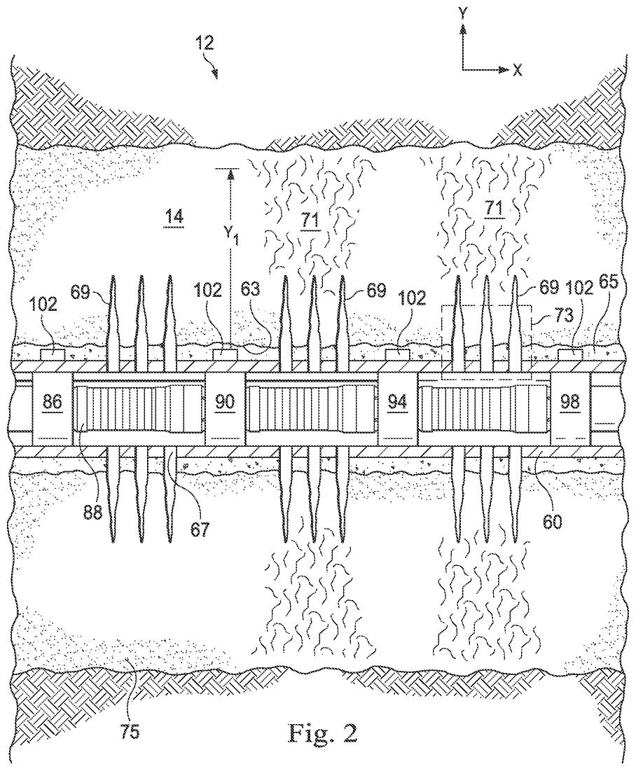

Turning to FIG. 2, a portion of a deviated wellbore 12 that has been perforated and hydraulically fractured is illustrated in more detail. During the process of hydraulic fracturing, millions of gallons of water, sand, and chemicals may be pumped underground to break apart the rock and release the gas. For example, a pumping system (not shown) may inject the millions of gallons of water, sand, and chemicals at high pressure down and across into the horizontally drilled well as far as 10,000 feet below the surface 16. The pressurized mixture may cause the rock layer 75 surrounding wellbore 12 to crack, forming fractures 71, which fractures 71 may be held open by the sand particles so that natural gas can flow up the well.

Casing 60 is illustrated as being deployed in a wellbore 63 drilled in formation 14. Securing casing 60 within wellbore 63 is a cement sheath 65 surrounding casing 60. Apertures 67 are illustrated as having been formed in casing 60 adjacent flow control screen assemblies 88 (such as through the perforation process). Packers 86, 90, 94, 98 are deployed between flow control screen assemblies 88 to establish separate production zones. Perforations 69 are formed adjacent apertures 67 and extend radially outward through the cement sheath 65 into formation 14. Resulting from the hydraulic fracturing process are fractures 71 extending from perforations 69. In FIG. 2, wellbore 12 is illustrated as passing through an area of formation 14 that is highly compressive in nature, such as may be found in tectonic regions. As such, it will be appreciated that fractures 71 are planar in nature as illustrated. Thus, following hydraulic fracturing, when the formation relaxes in the overburden area immediately adjacent perforations 69, which area is generally designated by zone 73 in FIG. 2, point stresses on casing 60 and/or cement sheath 65 may occur, leading to casing deformation. After hydraulic fracturing is conducted on the cased wellbore, the formation relaxes, and the load is applied back down on the horizontal wellbore.

Geological areas that experience active Earth movement may be prone to casing deformations or stresses in wellbore casings, especially those areas in which hydraulic fracturing operations have been conducted. Accordingly, in embodiments of the disclosure, geologic areas in a formation that are prone to casing deformation are identified. The root cause of casing deformation failures may be confirmed by analyzing microseismic events (monitored during and post hydraulic fracturing operations), alone or in combination with other data such as hydraulic fracturing treatment data, casing specifications, geo-mechanic one dimensional (1D) stress analysis, 3-D finite element modeling of the near wellbore region, and geological settings.

Once the root cause of casing deformation has been determined to be the result of highly active geological settings (as evidenced by the presence of a certain degree of microseismic events), techniques disclosed herein may be used to mitigate or resolve casing deformation in such areas. For example, the drilling plan may be altered for one or more wellbores to be drilled within a threshold distance of the geologic area that was identified as being prone to casing deformation.

For geological areas with thrust faults, a very high pump pressure is required to induce the fracture in the formation relative to typical pump pressures for fracturing operations. These high pressures may have a supercharging effect on the pore pressure in the near wellbore region. Two dominant effects can occur due to such increase in pore pressure. A first effect of such high pore pressure may reduce the effective stress, causing slippage on faults that are not critically stressed. Such faults may have slow slippage over a longer period of time even after the pumping has stopped. A second effect may result in formation relaxation once the pressure is released. In such a process the deformed rock may show slippage and be unable to maintain integrity around the wellbore region. The resulting hoop failure around the wellbore may result in formation collapsing on the casing.

Thus, in areas of active tectonic compression, casing deformation may occur when the formation relaxes or there is slippage on faults. The formation relaxation or shear slippage during closing fracture may result in microseismic events, namely seismic events resulting in seismic signals that are locally constrained about the area of the fracture, i.e., “microseismic signals.” This micro-seismicity is generated due to shear slippage of the rock. In the case of the fracture opening and closing are very slow activities and for this reason, may not generate a seismic signal that shows up on microseisms under normal conditions. The pump pressures that are generated while hydraulically fracturing formation in reverse/thrust fault areas may be very high. These high pressures may tend to cause otherwise less critically stressed faults/fractures to slip. In normal faulting, critically stressed faults/fractures may slip as is the case in water injection wells. In this case, relatively stable faults and fractures may tend to slip due to high injection pressure. These relatively stable faults and fractures may show slow slippage and may be noticed on microseisms after the pumps have stopped.

A relationship exists between the occurrence of planar fractures about the wellbore resulting from the hydraulic fracturing and point loading on the wellbore casing when the formation relaxes. For tectonically relaxed areas characterized by normal faulting, the least stress should be horizontal; the fractures produced are substantially vertical, and the injection pressure is less than that of the overburden. In this example, the overburdened stress of the overlying formation is higher than the other horizontal stresses. In areas of active tectonic compression, the least stress should be vertical and equal to the pressure of the overburden; the fractures should be horizontal, and injection pressures should be equal to, or greater than, the pressure of the overburden. If horizontal stresses are greater than vertical stresses, planar fractures, which lead to point loading and thus, casing deformation, may occur. It should be understood that while the description is primarily focused on fractures propagated horizontally, formation relaxation may refer to cases in which fractures propagated are horizontal. In any event, fractures 71 that are planar in nature may indicate that the surrounding geologic area is tectonically active and prone to formation relaxation.

While the disclosure focuses on analysis of micro-seismic activity at points of interest in a formation, in some embodiments, it is beneficial to review the well construction parameters (e.g., wellbore casing, casing states, etc.) as well to ensure that the casing deformation is not associated with the well construction. By examining the wellbore's design and determining that the design minimally impacts observed casing deformation, the probability of the casing deformation being related to the geological event, i.e., the microseismic activity, is higher. Thus, in some embodiments, it is desirable to analyze wellbores in a formation where casing deformation has occurred in order to predict where casing deformation is likely to occur in the existing formation or formations with similar geological composition and conditions. For example, wells that have experienced casing deformation or collapse post hydraulic fracturing treatment may be identified, and the field data sets of these wells may be analyzed.

In one or more embodiments, following analysis of microseismic activity, a three-dimensional (3-D) geo-mechanical model may be developed to understand existing stresses in the geographic area and predict areas where casing deformation could potentially occur. Geo-mechanical properties of the geographic area may be determined based on image logs, four arm caliper logs, overall seismic activity in the geographic area, and even problems experienced by structures in the area. A model may be created to establish the stress regime within the geographic area. Indications of highly compressive regimes are areas that are prone to casing failure post hydraulic treatment. This is particularly true where errors may have occurred while setting the casing, especially in the deep wells.

More specifically, the possibility of planar fracturing may be predicated with regard to the surrounding geologic area using locally placed seismic sensors (such as geophones, accelerometers or the like) to identify microseismic events. It will be appreciated that following hydraulic fracturing operations, as the fractures begin to close, wells may continue to emit microseismic events post hydraulic fracturing. For example, in FIG. 2, after hydraulic fracturing has been conducted along a portion of cased wellbore 12, sensors 102 locally positioned adjacent to a fractured portion of the formation may be utilized to record microseismic activity occurring within a first threshold (Y₁) distance of the wellbore.

Microseismic monitoring may provide passive observation of very small-scale seismic events, which occur in the ground as a result of hydraulic fracturing. The small-scale seismic events may be referred to as micro-seismic events or microseisms and may be too small to be felt on the surface, but they can be detected by seismic sensors such as geophones and accelerometers that may be locally positioned in the formation, such as along a wellbore drilled in the formation. These seismic sensors can detect micro-seismic signals generated from the micro-seismic events.

The seismic sensors may be used to monitor the rock being stressed within the first threshold distance Y₁ of the wellbore 12. In some examples, seismic sensors are deployed in one or more wellbores 12 within the formation 14 and the seismic sensors are utilized to monitor microseismic activity within the formation 14. The microseismic recordings and interpretation of hydraulic treatments provide a cloud of stress events (e.g., microseisms) indicating how much of the surrounding rocks is being disturbed by localized hydraulic fracturing. A first set of microseismic events may be measured prior to conducting the hydraulic fracturing. Additionally, a second set of microseismic events may be measured after the hydraulic fracturing has begun. Finally, in some embodiments, an additional set of microseismic events may be measured following cessation of hydraulic fracturing. The microseismic monitoring may be used as a post hydraulic fracturing tool to confirm the presence of formation relaxation.

In some examples, with reference back to FIG. 1, prior to conducting the hydraulic fracturing in the first horizontal wellbore 12a, seismic sensors 102 may be deployed in a second wellbore 12b to be hydraulically fractured. The second wellbore is drilled within the second threshold distance Y₂ in the formation 14 adjacent to the wellbore 12. Seismic sensors 102 may be deployed in the second wellbore 12b in order to better understand the geographic area surrounding the second wellbore 12b. By deploying the seismic sensors along adjacent wellbores, target production areas having a high potential of casing deformation post hydraulic fracturing may be identified prior to hydraulic fracturing.

The microseismic recordings may include the magnitude, location, and timestamp of each microseismic event within a set of microseismic events, which may be interpreted vis-à-vis the location of the wellbore in order to establish the stress and geological conditions changing around the wellbore 12 during and after the hydraulic treatments. In some examples, the microseismic recordings may be distributed in bins based on a timeline in accordance with the magnitude and location of the microseisms. The stress and geological conditions that are changing within a threshold distance Y₁ of the wellbore 12 may be established based on the distributed set of microseismic events. A large amount of microseismic activity occurring post hydraulic fracturing may indicate sufficient near wellbore formation relaxation and/or slip on faults creating a high likelihood of casing deformation. Accordingly, it may be advantageous to incorporate the post injection microseisms into geo-mechanical models to predict the stresses in and around the wellbore 12 after ceasing fracturing treatment.

Collection of microseismic event data, as well as analysis and modeling utilizing the data may be performed utilizing one or more processing and control systems 121 in communication with the sensors 102. Processing systems 121 may include any or all of the following: (a) a processor for executing and otherwise processing instructions, (b) one or more network interfaces (e.g., circuitry) for communicating between the processor and other devices, those other devices possibly located across a network; (c) a memory device (e.g., FLASH memory, a random access memory (RAM) device or a read-only memory (ROM) device for storing information (e.g., instructions executed by the processor and data operated upon by the processor in response to such instructions)). In some embodiments, the processing systems 121 may also include a separate computer-readable medium operably coupled to the processor for storing information and instructions as described further below. In some examples, processing systems 121 includes a memory that stores microseismic activity occurring within a first threshold distance of the cased wellbore 12 and also includes one or more processors in communication with the memory and operable to cause the system to record the microseismic activity occurring within the first threshold distance Y₁ of the wellbore after hydraulic fracturing is conducted along a portion of the wellbore, establish stresses on the wellbore casing at one or more points, and determine, based on the recorded microseismic activity and the stresses on the casing, whether a geologic area in the formation within a second threshold distance Y₂ of the wellbore is likely to be prone to deformation relaxation.

As stated above, while there may be any number of causes for casing failure, in formations situated in tectonically active regions, the likelihood increases that casing failure may be the result of formation relaxation or slip on faults, i.e., formation movement post injection. In some examples, stresses may be established on the wellbore casing 60 at one or more points. Stresses on the wellbore casing 60 may be established by considering point loading, especially for compressive regimes by, for example, performing classical load analysis or three-dimensional (3-D) Finite Element Modeling. Point loading may include performing load analysis or performing an advanced mode on a 3-D finite element model. In some examples, a step-by-step incrementing load is observed on the wellbore casing 60 and a deformation of the casing in response to the incremental load.

In some examples, initial stress conditions for the casing 60 may be established. The overall load on the casing 60 may be determined and the portion under tension or under compression may be identified. In one or more embodiments, the tensile strength and compressive load parameters of the cement disposed about the wellbore casing 60 may be evaluated to determine if the cement is disposed to distribute the point load (as opposed to passing the point load onto the casing, potentially resulting in casing deformation). For example, cement is typically designed to take compressive loads and may test at, for example, 3000-5000 per square inch (psi). In contrast, a test for the tensile strength may fail within the range of 100-200 psi, which indicates that the cement has a low tensile strength. It may be desirable to determine the loss of cement sheath integrity owing to tensile failure during hydraulic fracturing. To do so, the effect of tensile loads on the cement sheath 65 during fracturing operations may be calculated.

It will be appreciated that in some instances, hydraulic fracturing may place the cement sheath 65 in tension which may lead to premature failure of a portion of the cement sheath 65. Once the cement sheath 65 has failed (as a result of hydraulic fracturing) and the hydraulically fractured formation starts relaxing, the casing no longer has the protection of the cement sheath. Rather, the cement may be acting like a conduit for stress transfer from the settling overburden, inducing point loading and leading to casing failure.

It may be desirable to consider the compression and tensile loads on the cement sheath 65. In some embodiments, a compressive strength and tensile strength of the cement disposed about the casing 60 is determined. Thereafter, utilizing the results of this determination, the likelihood of casing deformation can be evaluated. In this regard, a threshold degree of microseismic activity that would subject a particular casing 60 to casing deformation may be determined based on the construction parameters of the wellbore (such as compressive strength and tensile strength of the cement, thickness of the casing itself, etc.), and thereafter it may be determined whether the microseismic activity in the formation adjacent the threshold degree of microseismic activity is above such threshold within the first threshold distance of the wellbore 12. A threshold for microseismic activity will be given by the amplitude of the microseismic signal and distance of the microseismic signal from the sensor array. A microseismic event that correlates to casing deformation may signify the energy dissipated during such an event.

In one or more embodiments, a stress imposed on the casing 60 during hydraulic fracturing is calculated. The calculated stress may include a thermal load on the casing 60. Thermal loadings may alter the thermal stress or elongating of the casing 60. If the casing 60 elongates and there is insufficient room for the casing 60 to move, the casing 60 may buckle and enter a deformed state.

Additionally, an effect of one or more loads imposed on the cement sheath 65 about the casing 60 during hydraulic fracturing may be calculated. The loads may lead to tensile loads (e.g., radial cracks), shear damage of the cement, inner or outer de-bonding, and/or plastic deformation in the casing 60. The determination of whether the wellbore 12 is prone to casing deformation may further include utilizing the calculated stress imposed on the casing 60 and the effect of combined loads imposed on the cement sheath 65. Based on the effect of combined loads imposed on the cement sheath, a loss of cement sheath integrity owing to a tensile, radial, shear, and/or de-bonding failure during hydraulic fracturing may be determined. This determination of the loss of cement sheath integrity may be carried out using 3-D numerical simulation software.

It may be determined, based on the recorded microseismic activity, whether a geologic area in the formation within a second threshold distance Y₂ of the wellbore 12 is prone to formation relaxation. The second threshold distance may be equal to or greater than the first threshold Y₁ distance. In response to a determination that the threshold degree of microseismic activity does not occur within the first threshold distance of the wellbore 12, it is determined that the geologic area within the second threshold distance of the wellbore 12 is not prone to casing deformation following hydraulic fracturing.

In contrast, in response to a determination that the threshold degree of microseismic activity occurs within the first threshold distance of the wellbore 12, it is determined that the geologic area within the second threshold distance of the wellbore 12 is prone to casing deformation following hydraulic fracturing. Based on a determination that the geologic formation within the second threshold distance of the wellbore 12 is prone to formation relaxation, the probability of casing deformation in a second wellbore to be drilled within the second threshold distance of the wellbore 12 may be mitigated by altering the drilling plan for the second wellbore.

In some embodiments, casing deformation may be mitigated by determining that a geologic area in a formation within a threshold distance of cased wellbore 12 is prone to formation relaxation and altering a drilling plan for one or more wellbores to be drilled within the threshold distance of the wellbore. Several alternative drilling plans may be implemented to mitigate the casing deformation. In an example, the drilling plan for the second wellbore may be altered by changing the planned direction of the second wellbore to be drilled. In this example, it may be determined that the planned direction of the second wellbore to be drilled has a higher probability of formation relaxation than a second direction. By changing the direction of the second wellbore, the probability of casing deformation may be reduced. It will be appreciated that in one or more embodiments, to the extent a second threshold distance is determined based on the first threshold distance, the second wellbore may be drilled to be outside of, or farther away from the first wellbore than the second threshold distance.

In some embodiments, the drilling plan for the second wellbore may be altered by changing the shape of the second wellbore to be drilled. In this example, it may be determined that the planned shape of the second wellbore to be drilled has a higher probability of formation relaxation than a second shape. By changing the shape of the second wellbore, the probability of casing deformation may be reduced.

In some embodiments, the drilling plan for the second wellbore may be altered by changing the dimensions of the second wellbore to be drilled. In this example, it may be determined that the planned dimensions of the second wellbore to be drilled have a higher probability of formation relaxation than the second dimensions. The dimensions of the wellbore may be changed by, for example, changing the depth of the wellbore or the diameter of the wellbore.

In some embodiments, the drilling plan for the second wellbore may be altered by changing the casing size to be used in the second wellbore to be drilled. In this example, it may be determined that the planned casing size of the second wellbore to be drilled has a higher probability of formation relaxation than a second casing size. The planned casing size may be smaller or larger than the final casing size of the second wellbore to be drilled.

In some embodiments, the drilling plan for the second wellbore may be altered by altering a planned cement characteristic used in association with the second wellbore to be drilled. In some embodiments, it may be determined that the planned cement characteristic of the second wellbore to be drilled has a lower elasticity to mitigate point load on the second wellbore casing than a second cement characteristic. In some embodiments, it may be determined that the planned cement characteristic of the second wellbore to be drilled has a lesser tensile strength than a second cement characteristic. The second cement characteristic may be, for example, latex based or foam based.

In some embodiments, the drilling plan for the second wellbore may be altered by diverting the direct stresses on a second wellbore casing. For example, the original drilling plan may include drilling a first opening for a second wellbore of the one or more wellbores. Diverting the direct stresses on the second wellbore casing may include drilling a second opening having a larger or smaller diameter than the first opening for the second wellbore. Additionally, diverting the direct stresses may include using under-reamers and cementing the well thereby increasing a gap between the second wellbore and the second wellbore casing.

In some embodiments, the drilling plan for the second wellbore may be altered by providing a crumple zone between the formation and the second wellbore casing. A crumple zone absorbs an impact and facilitates the distribution of the force of an impact from an impact point or area to other portions of the second wellbore casing.

In some embodiments, the drilling plan for the second wellbore may be altered by using swellable packers in a second wellbore of the one or more wellbores to minimize the effect of formation relaxation in the second wellbore. Swellable packers may swell upon contact with wellbore fluids. In some embodiments, the drilling plan for the second wellbore may be altered by using casing compaction joints that contract to absorb formation movement in the second wellbore.

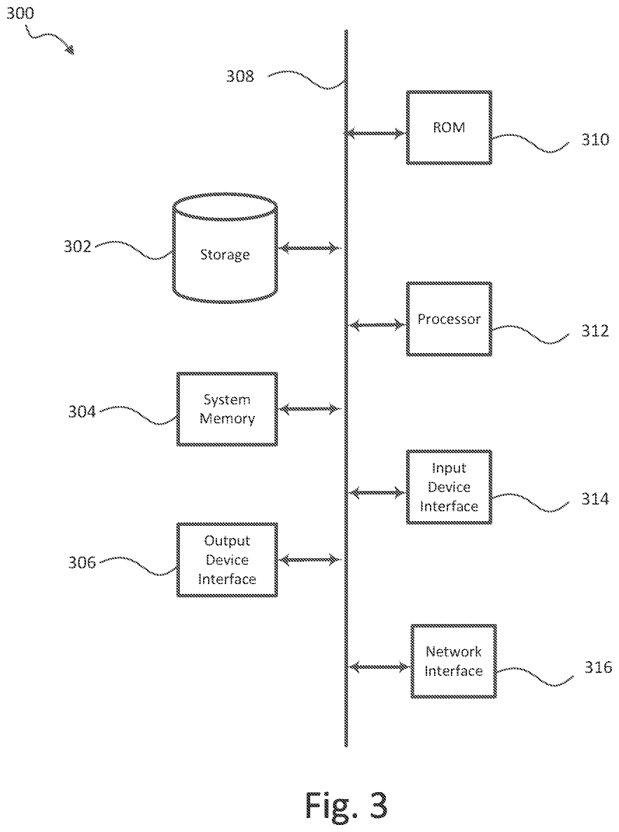

FIG. 3 is a block diagram of an exemplary computer system 300 in which embodiments may be implemented. Computer system 300 may generally comprise processing and control system 121 of FIG. 1. In this regard, computer system 300 may be coupled to wellbore drilling and production system 10. System 300 can be a workstation, a laptop computer, a tablet computer, a server computer, a smartphone, and/or the like, or any other type of electronic device. Such an electronic device includes various types of computer readable media and interfaces for various other types of computer readable media. As shown in FIG. 3, system 300 includes a permanent storage device 302, a system memory 304, an output device interface 306, a system communications bus 308, a read-only memory (ROM) 310, processing unit(s) 312, an input device interface 314, and a network interface 316.

Bus 308 collectively represents all system, peripheral, and chipset buses that communicatively connect the numerous internal devices of system 300. For instance, bus 308 communicatively connects processing unit(s) 312 with ROM 310, system memory 304, and permanent storage device 302.

From these various memory units, processing unit(s) 312 retrieves instructions to execute and data to process in order to execute the processes of the subject disclosure. The processing unit(s) can be a single processor or a multi-core processor in different implementations.

ROM 310 stores static data and instructions that are needed by processing unit(s) 312 and other modules of system 300. Permanent storage device 302, on the other hand, is a read-and-write memory device. This device is a non-volatile memory unit that stores instructions and data even when system 300 is off. Some implementations of the subject disclosure use a mass-storage device (such as a magnetic or optical disk and its corresponding disk drive) as permanent storage device 302.

Other implementations use a removable storage device (such as a floppy disk, flash drive, and its corresponding disk drive) as permanent storage device 302. Like permanent storage device 302, system memory 304 is a read-and-write memory device. However, unlike storage device 302, system memory 304 is a volatile read-and-write memory, such as random access memory. System memory 304 stores some of the instructions and data that the processor needs at runtime. In some implementations, the processes of the subject disclosure are stored in system memory 304, permanent storage device 302, and/or ROM 310.

Bus 308 also connects to output device interface 306 and input device interface 314. Input device interface 314 enables the user to communicate information and send commands to the system 300. Input devices used with input device interface 314 include, for example, alphanumeric, QWERTY, or T9 keyboards, microphones, and pointing devices (also called “cursor control devices”). In an example, a user may alter a drilling plan for one or more wellbores to be drilled using input device interface 314.

Output device interface 306 enables, for example, the display of images generated by the system 300. Output devices used with output device interface 306 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 3, bus 308 also couples system 300 to a public or private network (not shown) or combination of networks through a network interface 316. Such a network may include, for example, a local area network (“LAN”), such as an Intranet, or a wide area network (“WAN”), such as the Internet. Any or all components of system 300 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

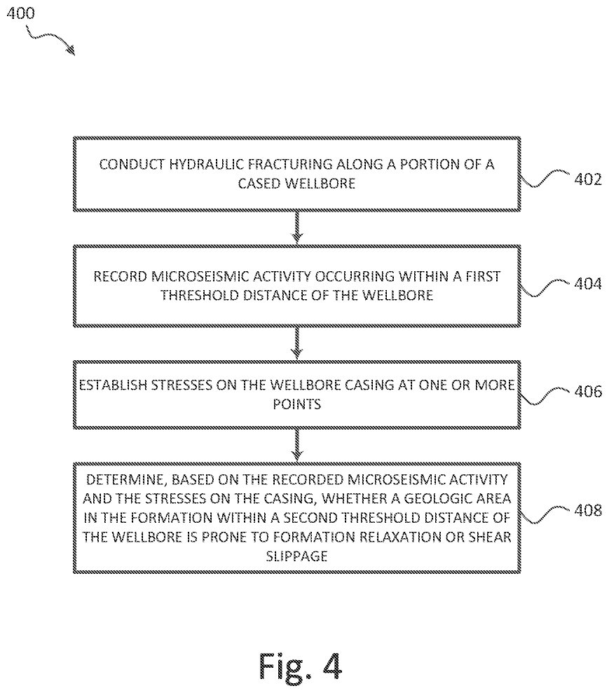

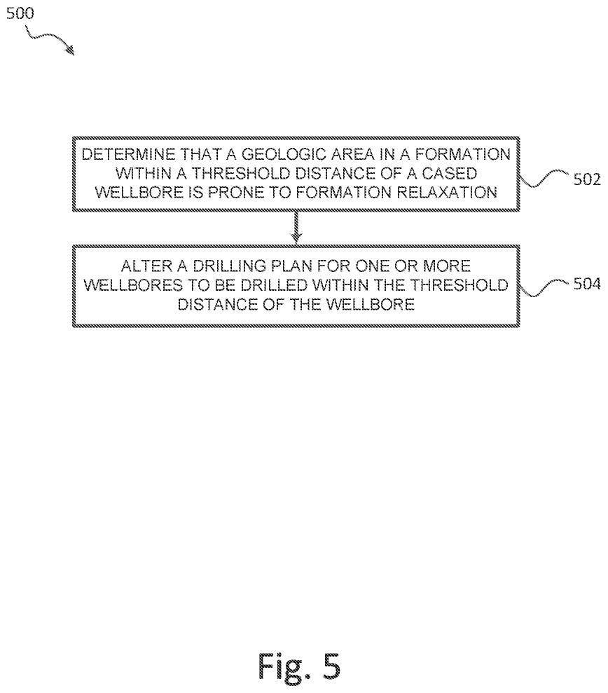

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the steps of method 400 of FIG. 4 and/or method 500 of FIG. 5 as described below, may be implemented using system 300 or any computer system having processing circuitry or a computer program product including instructions stored therein, which, when executed by at least one processor, causes the processor to perform functions relating to these methods.

As used in this specification and any claims of this application, the terms “computer,” “server,” “processor,” and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data to a client device (e.g., for purposes of displaying data to and receiving user input from a user interacting with the client device). Data generated at the client device (e.g., a result of the user interaction) can be received from the client device at the server.

FIG. 4 is a process flowchart of an exemplary method 400 of identifying geologic areas in a formation that are prone to casing deformation in accordance with one or more embodiments. Method 400 is not meant to be limiting and may be used in other applications. As shown in FIG. 4, method 400 includes steps 402, 404, 406, and 408. For discussion purposes, method 400 will be described using computer system 300 of FIG. 3, as described above. However, method 400 is not intended to be limited thereto.

Step 402 of method 400 includes conducting enhanced hydrocarbon recovery activities within a wellbore. Although not intended to be limiting, in one or more embodiments, the enhanced activities may be conducted under high pressure. One such type of high pressure activity is hydraulic fracturing. Thus, in some embodiments, hydraulic fracturing is conducted along a portion of a cased wellbore. Generally, as will be appreciated, treatment fluid is pumped under high pressure into the wellbore down to the perforated portions of the casing, where the high pressure fluid migrates into the formation. Hydraulic fracturing as described herein is not limited to a particular type, fluid, pressure, etc. but generally includes any type of hydraulic fracturing.

In a step 404, microseismic activity occurring within a first threshold distance from the wellbore is recorded. Seismic sensors may be used to detect microseismic events as they occur about the wellbore. In this regard, seismic sensors may be deployed in the wellbore during installation of the casing, so as to be encased in the cement sheath outside of the casing. Moreover, the seismic sensors may be utilized to detect seismic activity prior to hydraulic fracturing to establish a baseline of microseismic activity, during hydraulic fracturing, and after hydraulic fracturing during formation relaxation. Data from the sensors may be transmitted to a monitoring and control station 121.

In a step 406, stresses on the wellbore casing at one or more points are established. In one or more embodiments, stresses on the wellbore casing 60 may be established by considering point loading, especially for compressive regimes by, for example, performing classical load analysis or three-dimensional (3-D) Finite Element Modeling.

In a step 408, it is determined, based on the recorded microseismic activity and the stresses on the casing, whether a geologic area in the formation within a second threshold distance of the wellbore is prone to formation relaxation or shear slippage.

It is understood that additional processes may be inserted before, during, or after steps 402, 404, 406, and 408 discussed above. It is also understood that one or more of the steps of method 400 described herein may be omitted, combined, or performed in a different sequence as desired.

FIG. 5 is a process flowchart of an exemplary method 500 of mitigating casing deformation in accordance with one or more embodiments. Method 500 is not meant to be limiting and may be used in other applications. As shown in FIG. 5, method 500 includes steps 502 and 504. For discussion purposes, method 500 will be described using computer system 300 of FIG. 3, as described above. However, method 500 is not intended to be limited thereto.

Step 502 of method 500 includes determining that a geologic area in a formation within a threshold distance of a cased wellbore is prone to formation relaxation or shear slippage. The determination that a geologic area around a wellbore is prone to formation relaxation can be made in accordance with the steps described above with respect to method 400. In any event, it will be appreciated from the foregoing that formation relaxation or shear slippage occurs in areas where microseismic activity is prevalent, leading to point stresses on a wellbore casing that could lead to casing deformation. Moreover, while microseismic activity around a first wellbore may be prevalent, the determination must be made as to the extent of the microseismic activity within the formation, and in particular, whether the microseismic activity is likely to occur at another distance from the wellbore, namely a threshold distance where a second wellbore is planned for drilling.

In a step 504, a drilling plan for one or more wellbores to be drilled within the threshold distance of the wellbore is altered. This may include, among other things, changing the proposed path of the wellbore to be drilled, changing wellbore dimensions, changing proposed casing diameter, changing proposed casing thickness, changing proposed cement composition, sheath diameter or cementing plan, or making other changes as set forth above. It is understood that additional processes may be inserted before, during, or after steps 502 and 504 discussed above. It is also understood that one or more of the steps of method 500 described herein may be omitted, combined, or performed in a different sequence as desired.

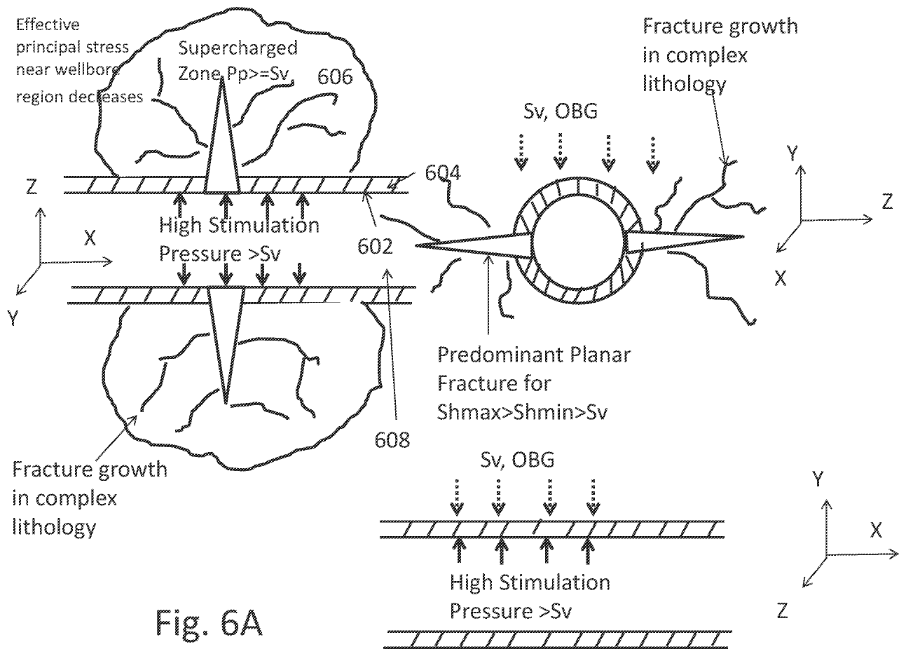

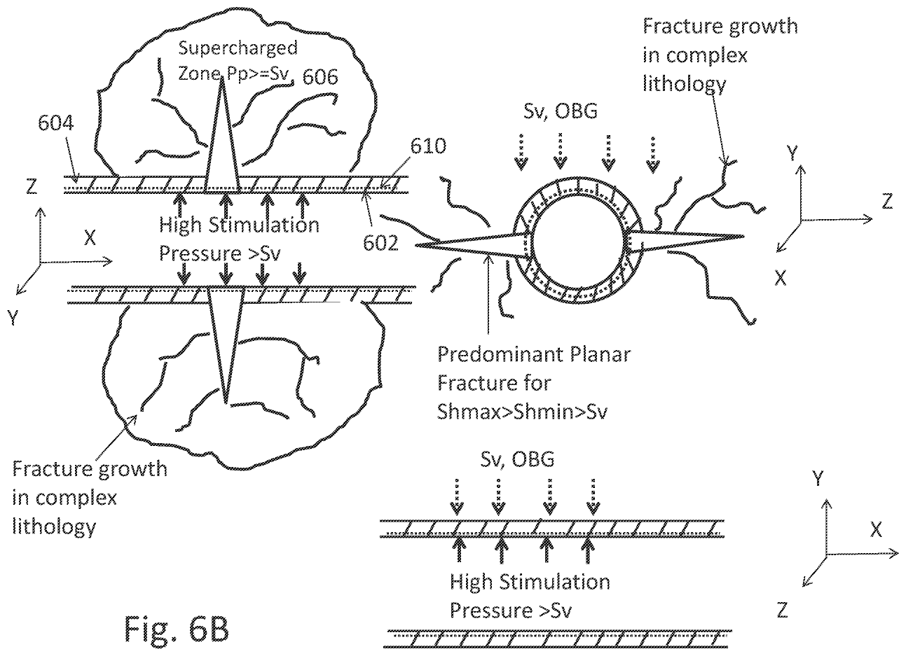

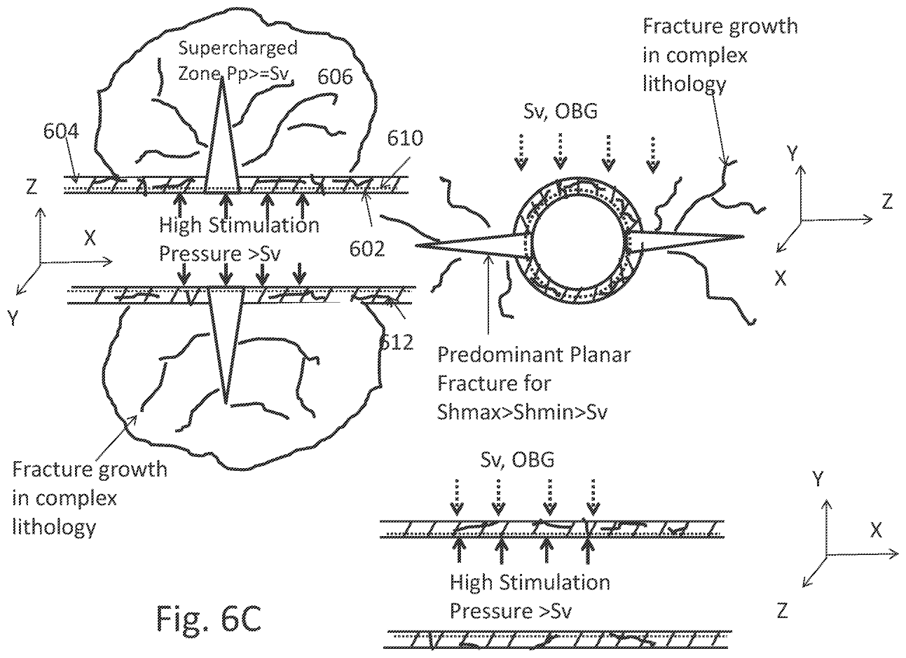

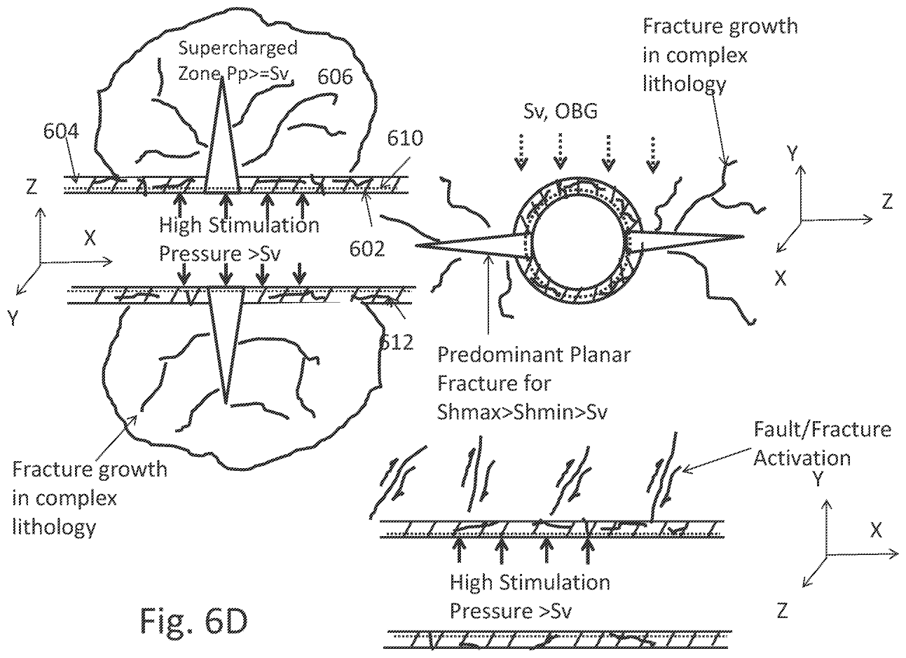

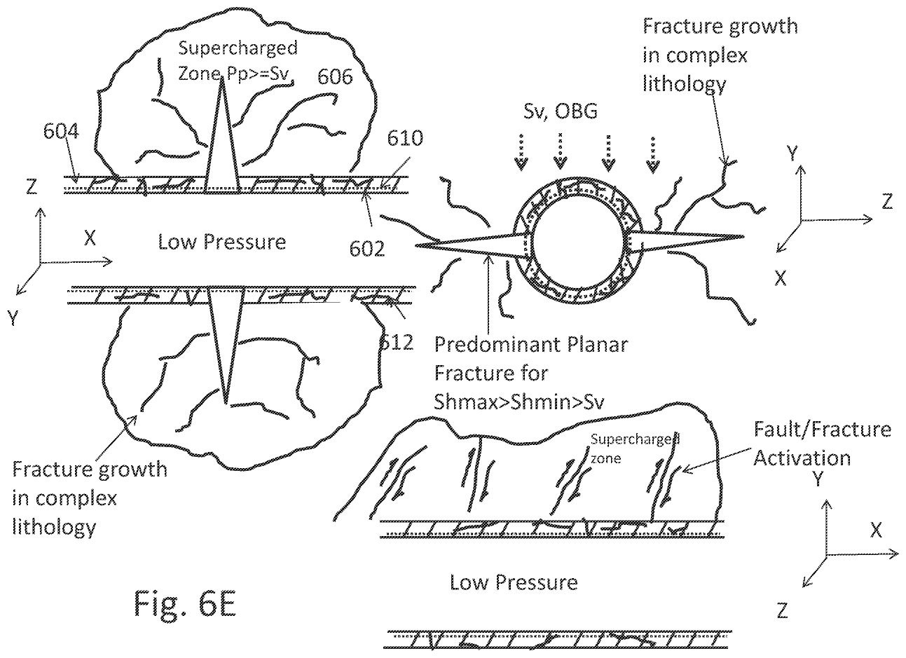

FIGS. 6A-6F are illustrations of hydraulic fracturing at different stages. FIG. 6A is an illustration of a casing 602, cement sheath 604, and simulated formation 606 at the start of hydraulic fracturing. The pressure inside a pipe 608 is high to hydraulically fracture the formation. The stress profile is thrust profile in nature with Shmax>Shmin>Sv, so the pressures required to initiate the fracturing can be expected to be above Sv. The fracture job may result in creating a predominantly planar fracture with some complexity due to lithology. As the fracture grows, the formation in the stimulated region supercharges due to effect of high pressure. This may result in a decrease in effective stresses around the wellbore.

FIG. 6B is an illustration of an effect of high fracturing pressure inside casing 602. The high fracturing pressure may result in a casing ballooning 610 effect on casing 602. Both casing 602 and cement sheath 604 may be subjected to some movement due to this pressure. The pressure inside casing 602 may exert bust loads. If the burst rating of casing 602 is high enough, then a failure may not occur at this time.

FIG. 6C is an illustration of high fracturing pressure resulting in cement sheath failure. In the example illustrated in FIG. 6C, the high fracturing pressure may result in the ballooning of casing 602 and stress in cement sheath 604. The ballooning and stress may result in the development of radial and circumferential cracks 612 in cement sheath 604. Cement sheath 604 may degrade and no longer provide any protection from the external loads applied on casing 602. The techniques in the present disclosure may be used to prevent casing deformation. The high pressure on casing 602 may not be a result of deformation, but it is creating damage in and/or near the wellbore that will result in the deformation.

FIG. 6D is an illustration of high fracturing pressure resulting in fault activation. In the example illustrated in FIG. 6D, the region near the wellbore has a supercharged formation due to fluid lost in fracture growth. The lowering of effective stresses may result in activation of faults. The faults that are critically stressed or close to critical stress regions may be affected the most, resulting in the development of a weak plane slip tendency near the wellbore. The weakening of the plane near the wellbore may not result in deformation but may lead to deformation when the pumping is stopped.

FIG. 6E is an illustration of casing 602, cement sheath 604, and simulated formation 606 after the pumping has stopped. FIG. 6F is an illustration of casing deformation. When the pumping has stopped, the casing deformation process may starts. The stimulated region that is supercharged may start to relax, and the slip planes formed near the wellbore may result in a weakened wellbore that is prone to collapse. The pressure inside casing 602 may be hydrostatic at this point and no longer provide any back up to prevent the collapse. Additionally, cement sheath 604 may become deteriorated and no longer provide support from external loads. As the formation and re-activated faults start relaxing the load is applied directly on casing 602. This load may be a non-uniform load over a length of casing 602. Casing, however, is typically not designed to handle such non-uniform loads and may start to deform. The reason for casing deformation may be a post-hydraulic fracturing event when the pumps are stopped. This may be further supported by the micro-seismic events noted after the pumps are stopped.

Thus, generally a system for identifying geologic areas in a formation that are prone to casing deformation has been described. The system includes a memory that stores microseismic activity occurring within a first threshold distance of a cased wellbore; and one or more processors in communication with the memory and operable to cause the system to record the microseismic activity occurring within the first threshold distance of the wellbore after hydraulic fracturing is conducted along a portion of the wellbore; establish stresses on the wellbore casing at one or more points; and determine, based on the recorded microseismic activity and the stresses on the casing, whether a geologic area in the formation within a second threshold distance of the wellbore is prone to formation relaxation or shear slippage. Likewise, a method of identifying geologic areas in a formation that are prone to casing deformation has been described. The method includes conducting hydraulic fracturing along a portion of a cased wellbore; recording microseismic activity occurring within a first threshold distance of the wellbore; establishing stresses on the wellbore casing at one or more points; and determining, based on the recorded microseismic activity and the stresses on the casing, whether a geologic area in the formation within a second threshold distance of the wellbore is prone to formation relaxation or shear slippage.

Additionally, a generally a system for mitigating casing deformation has been described. The system includes a memory that stores one or more drilling plans for one or more wellbores to be drilled within a threshold distance of a wellbore; and one or more processors in communication with the memory and operable to cause the system to drill a first wellbore in a formation; determine that a geologic area in the formation within the threshold distance of the first wellbore is prone to formation relaxation; and alter a drilling plan for a second wellbore to be drilled within the threshold distance of the wellbore. Likewise, a method of mitigating casing deformation has been described. The method includes determining that a geologic area in a formation within a threshold distance of a cased wellbore is prone to formation relaxation; and altering a drilling plan for one or more wellbores to be drilled within the threshold distance of the wellbore.

Any of the foregoing embodiments may include any one of the following elements, alone or in combination with each other:
Establishing initial stress conditions of the casing; identifying a compressive strength and tensile strength of cement disposed about the casing; determining, based on the initial stress conditions and the compressive strength and tensile strength of the cement, whether the wellbore is prone to casing deformation; and in response to a determination that the wellbore is not prone to casing deformation, determining whether a threshold degree of microseismic activity occurs within the first threshold distance of the wellbore.
Calculating a stress imposed on the casing during hydraulic fracturing, the calculated stress including a thermal load on the casing; and calculating an effect of one or more loads imposed on a cement sheath about the casing during hydraulic fracturing, where determining whether the wellbore is prone to casing deformation further includes utilizing the calculated stress imposed on the casing and the effect of combined loads imposed on the cement sheath.
Determining, based on the effect of combined loads imposed on the cement sheath, a loss of cement sheath integrity owing to a tensile, radial, shear, or de-bonding failure during hydraulic fracturing.
In response to a determination that the threshold degree of microseismic activity occurs within the first threshold distance of the wellbore, determining that the geologic area within the second threshold distance of the wellbore is prone to casing deformation following hydraulic fracturing; and in response to a determination that the threshold degree of microseismic activity does not occur within the first threshold distance of the wellbore, determining that the geologic area within the second threshold distance of the wellbore is not prone to casing deformation following hydraulic fracturing.
Mitigating casing deformation of a second wellbore that is to be built within the geologic area of the formation.
Recording a magnitude and a location of each microseismic event within a set of microseismic events.
Distributing the set of microseismic events into bins based on a timeline.
Establishing, based on the distributed set of microseismic events, stress and geological conditions that are changing within a threshold distance of the wellbore.
Establishing stresses on the casing based on point loading by performing load analysis.
Establishing stresses on the casing based on point loading by performing an advanced mode on a three-dimensional (3D) finite element model.
Deploying microseismic sensors within the formation; and utilizing the microseismic sensors to monitor microseismic activity within the formation.
Based on a determination that the geologic formation within the second threshold distance of the wellbore is prone to formation relaxation, altering the drilling plan for one or more wellbores to be drilled within the second threshold distance.
Based on a determination that the geologic formation within the second threshold distance of the wellbore is prone to shear slippage, altering the drilling plan for one or more wellbores to be drilled within the second threshold distance.
Altering the drilling plan for one or more wellbores to be drilled within the second threshold distance by changing the planned direction of a second wellbore to be drilled, changing the shape of a second wellbore to be drilled, changing the dimensions of a second wellbore to be drilled, changing the casing size to be used in the second wellbore to be drilled, or changing a cement characteristic used in association with the second wellbore to be drilled.
Prior to conducting the hydraulic fracturing in a first wellbore, deploying microseismic sensors in the first wellbore, where the second wellbore to be drilled within the second threshold distance.
Measuring a first set of microseismic events prior to conducting the hydraulic fracturing; and measuring a second set of microseismic events after the hydraulic fracturing has begun.
Any embodiment may include drilling a second wellbore in a formation adjacent to the first wellbore; and deploying microseismic sensors in the second wellbore prior to hydraulically fracturing the first wellbore.
Determining that a planned direction of the second wellbore to be drilled has a higher probability of experiencing formation relaxation than a second direction, where altering the drilling plan includes changing the planned direction of the second wellbore to the second direction.
Determining that a planned shape of the second wellbore to be drilled has a higher probability of experiencing formation relaxation than a second shape, where altering the drilling plan includes changing the shape of the second wellbore to the second shape.
Determining that a wellbore with a planned first set of dimensions has a higher probability of experiencing formation relaxation than a second set of dimensions, where altering the drilling plan includes changing the planned first set of dimensions of the second wellbore to the second set of dimensions.
Determining that a wellbore with a planned first set of dimensions has a higher probability of experiencing shear slippage than a second set of dimensions, where altering the drilling plan includes changing the planned first set of dimensions of the second wellbore to the second set of dimensions.
Determining that a second wellbore with a first planned casing size has a higher probability of experiencing formation relaxation than a second casing size, where altering the drilling plan includes changing the planned casing size to be used in the second wellbore to the second casing size.
Determining that a second wellbore with a first planned casing size has a higher probability of experiencing shear slippage than a second casing size, where altering the drilling plan includes changing the planned casing size to be used in the second wellbore to the second casing size.
Altering a planned cement characteristic for one or more wellbores to be drilled within the threshold distance of the wellbore.
Determining that the planned cement characteristic of the second wellbore to be drilled has a lower elasticity to mitigate point load on the second wellbore casing than a second cement characteristic, where altering the planned cement characteristic includes changing the planned cement characteristic of the second wellbore to the second cement characteristic.
The second cement characteristic being latex based.
The second cement characteristic being foam based.
Determining that the planned cement characteristic of the second wellbore to be drilled has a lesser tensile strength than a second cement characteristic, where altering the planned cement characteristic includes changing the planned cement characteristic of the second wellbore to the second cement characteristic.
Determining that the geologic area is prone to formation relaxation by determining, based on a recorded micro-seismic activity within the first threshold distance of the wellbore and stresses on the wellbore casing, that the geologic area is prone to formation relaxation.
Determining that the geologic area is prone to shear slippage by determining, based on a recorded micro-seismic activity within the first threshold distance of the wellbore and stresses on the wellbore casing, that the geologic area is prone to formation relaxation.
Altering the drilling plan by diverting the direct stresses on a second wellbore casing.
A drilling plan that includes drilling a first opening for a second wellbore of the one or more wellbores, where diverting the direct stresses on the second wellbore casing includes drilling a second opening having a larger diameter than the first opening for the second wellbore.
Diverting the direct stresses by using under-reamers and cementing the well thereby increasing a gap between the second wellbore and the second wellbore casing.
Altering the drilling plan by providing a crumple zone between the formation and the second wellbore casing.
Altering the drilling plan by using swellable packers in a second wellbore of the one or more wellbores to minimize the effect of formation relaxation in the second wellbore.
Altering the drilling plan by using casing compaction joints that contract to absorb formation movement in a second wellbore of the one or more wellbores.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method of mitigating casing deformation, comprising:
determining that a geologic area in a formation within a threshold distance of a cased wellbore is prone to formation relaxation; and
altering a drilling plan for one or more wellbores to be drilled within the threshold distance of the wellbore.

2. The method of claim 1, further comprising:
determining that a planned direction of the second wellbore to be drilled has a higher probability of formation relaxation than a second direction, wherein altering the drilling plan includes changing the planned direction of the second wellbore to the second direction.

3. The method of claim 1, further comprising:
determining that a planned shape of the second wellbore to be drilled has a higher probability of formation relaxation than a second shape, wherein altering the drilling plan includes changing the shape of the second wellbore to the second shape.

4. The method of claim 1, further comprising:
determining that planned dimensions of the second wellbore to be drilled have a higher probability of formation relaxation than second dimensions, wherein altering the drilling plan includes changing the planned dimensions of the second wellbore to the second dimensions.

5. The method of claim 1, further comprising:
determining that a planned casing size of the second wellbore to be drilled has a higher probability of formation relaxation than a second casing size, wherein altering the drilling plan includes changing the planned casing size to be used in the second wellbore to the second casing size.

6. The method of claim 1, comprising:
altering a planned cement characteristic for one or more wellbores to be drilled within the threshold distance of the wellbore.

7. The method of claim 6, determining that the planned cement characteristic of the second wellbore to be drilled has a lower elasticity to mitigate point load on the second wellbore casing than a second cement characteristic, wherein altering the planned cement characteristic includes changing the planned cement characteristic of the second wellbore to the second cement characteristic.

8. The method of claim 7, wherein the second cement characteristic is latex based.

9. The method of claim 7, wherein the second cement characteristic is foam based.

10. The method of claim 6, determining that the planned cement characteristic of the second wellbore to be drilled has a lesser tensile strength than a second cement characteristic, wherein altering the planned cement characteristic includes changing the planned cement characteristic of the second wellbore to the second cement characteristic.

11. The method of claim 10, wherein the second cement characteristic is latex based.

12. The method of claim 10, wherein the second cement characteristic is foam based.

13. The method of claim 1, wherein determining that the geologic area is prone to formation relaxation includes determining, based on a recorded micro-seismic activity within the first threshold distance of the wellbore and stresses on the wellbore casing, that the geologic area is prone to formation relaxation.

14. The method of claim 1, wherein altering the drilling plan includes diverting the direct stresses on a second wellbore casing.

15. The method of claim 14, wherein the drilling plan includes drilling a first opening for a second wellbore of the one or more wellbores, and wherein diverting the direct stresses on the second wellbore casing includes drilling a second opening having a larger diameter than the first opening for the second wellbore.

16. The method of claim 15, wherein diverting the direct stresses further includes using under-reamers and cementing the well thereby increasing a gap between the second wellbore and the second wellbore casing.

17. The method of claim 1, wherein altering the drilling plan includes providing a crumple zone between the formation and the second wellbore casing.

18. The method of claim 1, wherein altering the drilling plan includes using swellable packers in a second wellbore of the one or more wellbores to minimize the effect of formation relaxation in the second wellbore.

19. The method of claim 1, wherein altering the drilling plan includes using casing compaction joints that contract to absorb formation movement in a second wellbore of the one or more wellbores.

20. A system for mitigating casing deformation, comprising:
a memory that stores one or more drilling plans for one or more wellbores to be drilled within a threshold distance of a wellbore; and
one or more processors in communication with the memory and operable to cause the system to:
determine that a geologic area in a formation within the threshold distance of the cased wellbore is prone to formation relaxation; and
alter a drilling plan for one or more wellbores to be drilled within the threshold distance of the wellbore.
